(19) United States
(12) Patent Application Publication
(10) Pub. No.: US 2025/0083933 A1
(43) Pub. Date: Mar. 13, 2025

(54) INDUSTRIAL TRUCK WITH A DRIVE SECTION AND A LOAD SECTION AND METHOD FOR ENTERING A PALLET

(71) Applicant: Jungheinrich Aktiengesellschaft, Hamburg (DE)

(72) Inventors: Michael Schüler, Wakendorf II (DE); Helmut Lohmann, Nartum-Gyhum (DE); Holger Brunckhorst, Norderstedt (DE); Marcel Krenzin, Bad Bramstedt (DE)

(73) Assignee: Jungheinrich Aktiengesellschaft, Hamburg (DE)

(21) Appl. No.: 18/827,091

(22) Filed: Sep. 6, 2024

(30) Foreign Application Priority Data
Sep. 8, 2023 (DE) 10 2023 124 341.1

(51) Int. Cl. B66F 9/075; B66F 9/12

(52) U.S. Cl. CPC B66F 9/07586; B66F 9/12

(57) ABSTRACT

An industrial truck including a drive section and a load section. The load section includes a load wheel lift including a support element, a load arm, and at least one load wheel positioned on the load arm. The at least one load wheel is structured to be pivoted via the load wheel lift into a folded-out position and into a folded-in position. The support element is structured to support the load arm in the folded-in position of the at least one load wheel. The support element supports the load arm when the load arm enters a pallet in the folded-in position and without the at least one load wheel being supported on the pallet.

### CROSS-REFERENCE TO RELATED APPLICATION

This a utility patent application based upon and claiming priority to, German Patent Application 10 2023 124 341.1, filed on Sep. 8, 2023, the entire contents of which is incorporated herein by reference.

### TECHNOLOGICAL FIELD

The present disclosure is directed to an industrial truck with a drive section and a load section, which has a load wheel lift.

### BACKGROUND

A key technical problem when using a load wheel lift is entering closed pallets that have a pallet board lying on the floor, for example, which obstructs a load wheel when entering. With the load wheel lift, the load arm is supported by a load wheel located at the front in the region of the load arm tip. There are various options for setting up the load wheel. For example, it is conceivable to use a single load wheel or a rocker with at least two load wheels. In order to pick up or set down the closed pallet, the load arm must enter the pallet pockets of the closed pallet and the pallet board must be covered with the load wheel. A lower cross board must also be covered when picking up Euro pallets on the long side. Thus, the wheel supported on the floor must climb onto the cross board in each case when entering the pallet. Various forms of climbing aids are known from the prior art for this purpose, which support the load wheel when it enters the closed pallet and raise it to such an extent that the height offset to be covered by the load wheel to the pallet board is as low as possible.

EP 3 718 854 B1 discloses an industrial truck with a step detection unit that is attached to the load arm and detects a step when the load arm enters or exits the closed pallet. In response to the detected step element, the load arm is lowered and a load wheel is raised until a support wheel is set down on the step. For entering and exiting the closed pallet, a support wheel is located in front of and behind the load wheel in relation to the longitudinal direction of the fork. It is also provided that the load wheel be set down on the cross board when the pallet is entered and that the load wheel rolls on the cross board when the closed pallet is entered or exited again. The support wheel arranged in front of the load wheel in the direction of entry serves as a climbing aid for the load wheel on the cross board.

### SUMMARY

The invention is based on the object of improving the entry into a closed pallet in such a way that displacement or damage to the pallet is avoided when it enters or exits.

In an embodiment, the industrial truck according to the invention has a drive section and a load section. The load section has a load wheel lift, which preferably has, for each load arm, a support element, a kinematic rod and a load wheel lever with at least one load wheel. The at least one load wheel is preferably pivoted via the load wheel lever with the kinematic rod into a folded-out and a folded-in position on the load arm. The support element is arranged on the load arm in such a way that in the folded-in position of the load wheel, the respective load arm is supported by the support element and the load wheel no longer has any contact with the floor. According to the invention, the support element supports the load arm when it enters the pallet without the load wheel coming into contact with the pallet or a pallet cross board. When entering the pallet, the support wheel does not rest on the pallet or a cross board of the pallet. Thus, entry into the pallet is effected without the load wheel having to come into contact with the pallet. A setting down of the load wheel on the ground is effected at the earliest after the load wheel has driven over the entire cross board. Due to the support element, contact of the load wheel with the cross board is avoided, and there is no need for a climbing aid, since the load wheel does not come into contact with the pallet.

In some embodiments, the support element is preferably equipped with at least two, three or more support rollers, which support the load arm when the load wheel is folded in. The distance between the support rollers is not greater than the smallest width of the narrowest cross board in the pallet. The distance between the support rollers is determined by their center distance. In contrast to the runners at the load arm tip known from the prior art, the support element has support rollers arranged one behind the other, with which a cross board of a closed pallet entrance can be driven over. Since the center distance of the support rollers is less than or equal to the smallest width of the cross board with the smallest width, a driving of the support element over the cross boards is effected particularly evenly and with little vibration. The following application does not differentiate between wheels and rollers.

In some embodiments, the support element can also be configured as a skid. With the skid, the pallet cross board can be covered when the pallet entry is closed without the load wheel coming into contact with it. The length of the skid can be considered to be its substantially horizontal portion. In particular, the length of the skid can correspond to at least the smallest width of a cross board of the pallet.

In a preferred embodiment, the support element is arranged on the load arm laterally next to the at least one load wheel. The support elements are preferably arranged in each case on both sides of the at least one load wheel. In relation to the longitudinal direction of the load arm, this means that in each case one support element is arranged to the left and/or one support element is arranged to the right of the load wheel. As a rule, one support element on each load arm is sufficient. The support elements can also be arranged in each case on a side of the load arm pointing away from the other load arm. With this embodiment, only one support element is provided on the outer side of each load arm. In contrast to an embodiment with individual support wheels in front of and behind the load wheel, the support element with lateral support wheels offers the advantage that a cross board can be driven over with the support rollers, without the load wheel having to be set down on the cross board and driven over it.

In a preferred embodiment, in each case at least one support roller is arranged in front of and behind the at least one load wheel in relation to the longitudinal direction of the fork. During the entry or exit of the vehicle, the entire distance can be covered without the load wheel being set down on the cross board _{[SMI]} if the distance between the support rollers is less than or equal to the width of the cross board. Preferably, a skid portion can also be provided on the support element to provide support in the event that, for example, one of the support rollers loses contact with the cross board.

In a preferred embodiment, the load arm is equipped with a U-shaped profile in the region of the load wheel and the load wheel, in its folded-in position, is fully or partially immersed in the U-shaped profile of the load arm. In this way, the support element is set down on the cross board.

In some embodiments, the support element preferably has a length that is greater than the greatest distance between two cross boards occurring in the direction of entry. Preferably, the support element here is longer than the first distance that occurs in the direction of entry between a pallet board and a center board of a pallet suitable for the industrial truck, for example greater than 227.5 mm. In this way, the support element can be used to move from one cross board to the next on standardized pallets, without the load wheel having to be folded out, in order to cover the distance between the cross boards.

Some aspects of the present disclosure are directed to embodiments of a method for entering a closed pallet with an industrial truck. The closed pallet has at least one pallet pocket into which the two fork tines of the industrial truck enter in order to lift or set down the pallet. The fork tines of the industrial truck in each case have a support element extending in the longitudinal direction of the fork. According to the invention, it is provided that the load section of the industrial truck moves to a first lifting height, at which the fork tines can be moved into the at least one pallet pocket at least almost without contacting it. After moving in, the load section is lowered to a second lifting height if at least one portion of the support element is above a pallet board, so that the support element contacts the pallet board. The pallet board borders the pallet pocket on the side facing the base. Subsequently, a raising of the load wheels to a folded-in position is effected, in which the load wheels do not come into contact with the pallet board or any other portion of the closed pallet. An entering of the pallet pockets with the load wheels folded in is then effected, so that the fork tines are supported by the support elements on the pallet boards and the load wheels do not support the fork tines on the pallet boards. Thus, the fork tines are driven into the pallet via the support elements and it is not necessary to support them on the pallet using the load wheels. In a subsequent step, the folding down of the load rollers is effected and a raising of the pallet to transport height is effected, if the load wheels are in a predetermined intermediate region that is free of pallet boards. This means that the load wheels are folded out so that the pallet can be raised using the fork tines.

### BRIEF DESCRIPTION OF THE DRAWINGS

A particularly preferred embodiment of the industrial truck according to the invention is described below with reference to the figures.

FIG. 1A shows an embodiment of an automatically guided industrial truck at a height position.

FIG. 1B shows an embodiment of an automatically guided industrial truck at a height position and carrying a pallet.

FIG. 1C shows an embodiment of an automatically guided industrial truck at another height position.

FIG. 1D shows an embodiment of an automatically guided

FIG. 2A shows an embodiment of an automatically guided industrial truck in an embodiment of a first lifting position of a closed pallet with a center board.

FIG. 2B shows an embodiment of an automatically guided industrial truck in an embodiment of a second lifting position of the closed pallet with a center board.

FIG. 2C shows an embodiment of an automatically guided industrial truck in an embodiment of a third lifting position of the closed pallet with a center board.

FIG. 2D shows an embodiment of an automatically guided industrial truck in an embodiment of a fourth lifting position of the closed pallet with a center board.

FIG. 2E shows an embodiment of an automatically guided industrial truck in an embodiment of a fifth lifting position of the closed pallet with a center board.

FIG. 2F shows an embodiment of an automatically guided industrial truck in an embodiment of a sixth lifting position of the closed pallet with a center board.

FIG. 2G shows an embodiment of an automatically guided industrial truck in an embodiment of a seventh lifting position of the closed pallet with a center board.

FIG. 3A shows an embodiment of an automatically guided industrial truck in an embodiment of a lifting position of the closed pallet without a center board.

FIG. 3B shows an embodiment of an automatically guided industrial truck in an embodiment of a lifting position of the closed pallet without a center board.

FIG. 3C shows an embodiment of an automatically guided industrial truck in an embodiment of another lifting position of the closed pallet without a center board.

FIG. 3D shows an embodiment of an automatically guided industrial truck in an embodiment of another lifting position of the closed pallet without a center board.

FIG. 3E shows an embodiment of an automatically guided industrial truck in an embodiment of another lifting position of the closed pallet without a center board.

### DETAILED DESCRIPTION

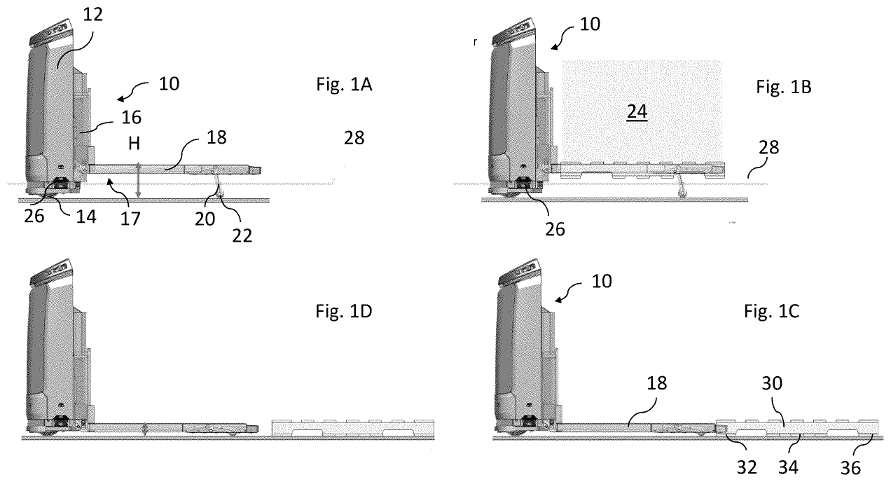

FIGS. 1A-D show a side view of an AGV (automatic guided vehicle) configured as a self-propelled industrial truck 10. In some embodiments, the industrial truck 10 has a drive section 12, which has a steered and driven wheel 14. The load section has load arms 18 and a lifting device 16. A kinematic rod 17 is actuated via the lifting device 16. A load wheel lever 20, which carries a load wheel 22 at its free end, is positioned over the kinematic rod 17. The exemplary embodiment shown has one load wheel 20, but vehicles with which two load wheels are arranged on a centrally mounted rocker are also possible.

FIG. 1A shows the vehicle with raised load arms 18 at a height position upon its empty run. Here, the lifting height H from the top of the load arm to the ground is 250 mm, for example. FIG. 1B shows the industrial truck 10 with a load 24 picked up. In some embodiments, the industrial truck is controlled by a laser scanner 26 both when traveling empty and when traveling with a load picked up. The laser scanner 26 scans the surroundings of the vehicle at scanning plane 28 in order to avoid collisions and control the movement of the vehicle. As shown in FIGS. 1A and B, the scanning plane 28 is below the raised load arms 18, so that the laser scanner 26 has a clear view.

FIG. 1C shows the lowered load arms 18 at another height position when entering a pallet 30. The pallet 30 has two cross boards 32 and 36 along with a center board 34. As a rule, the load arms are lowered to a height of 95-110 mm for the entry height in FIG. 1C, wherein a tolerance of +/−5 mm is sufficient for the height of the lowered fork in practical use.

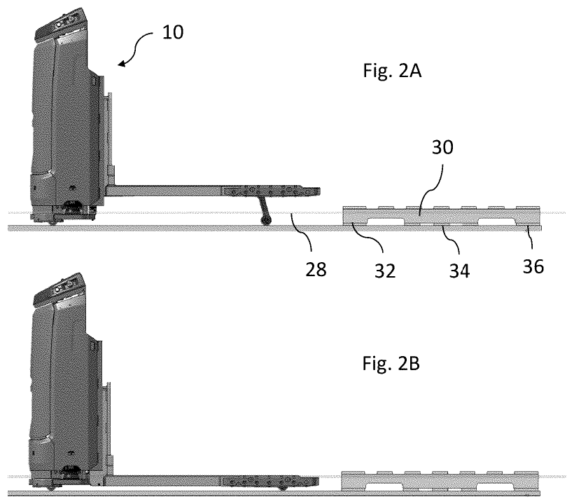

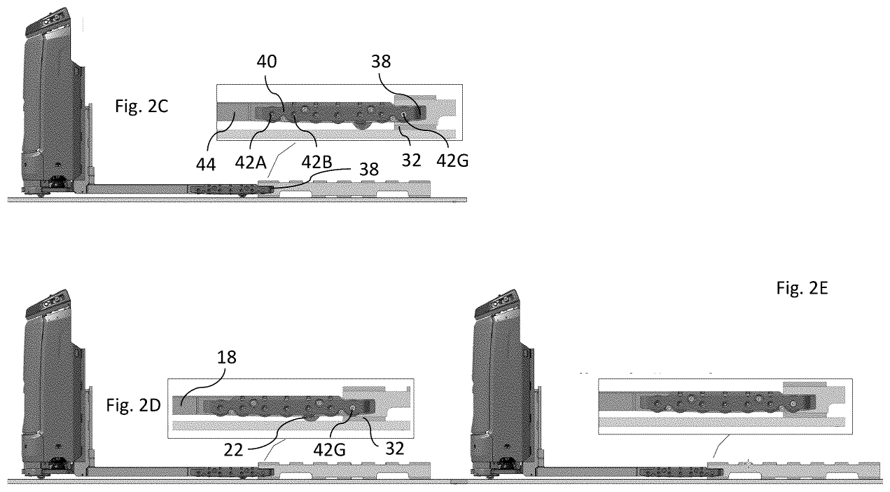

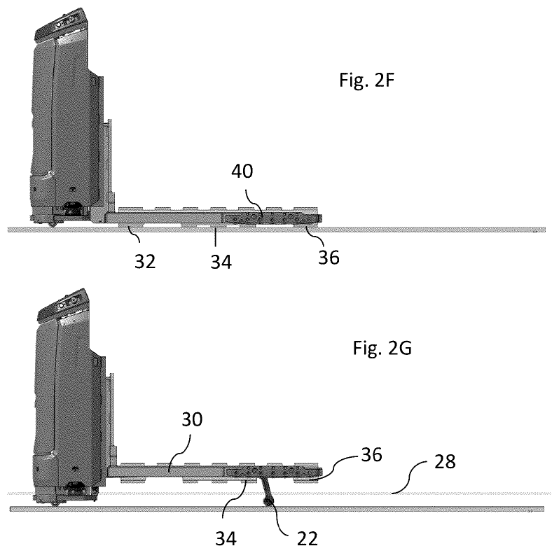

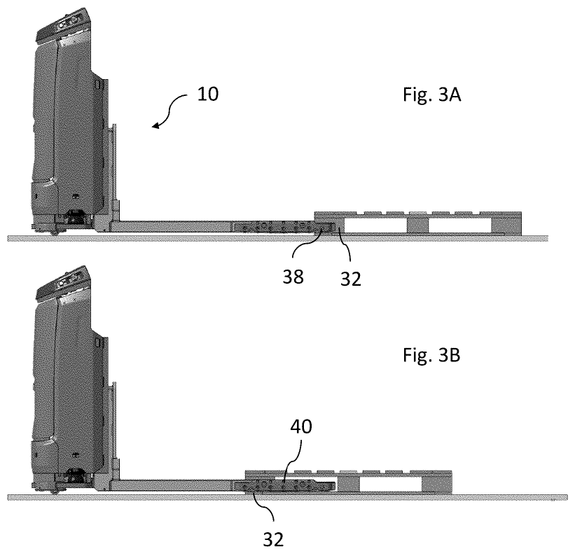

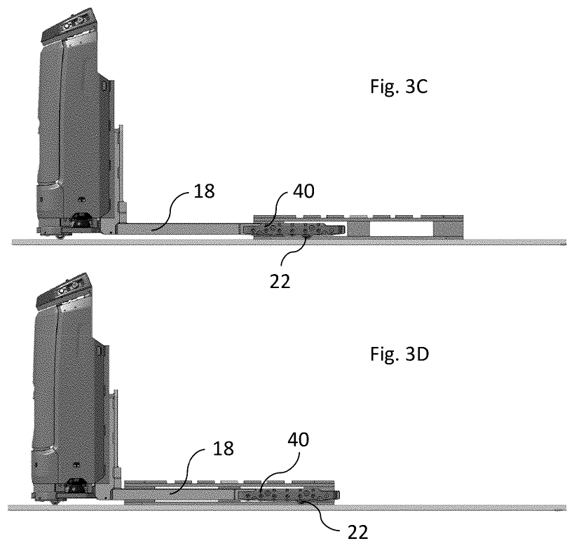

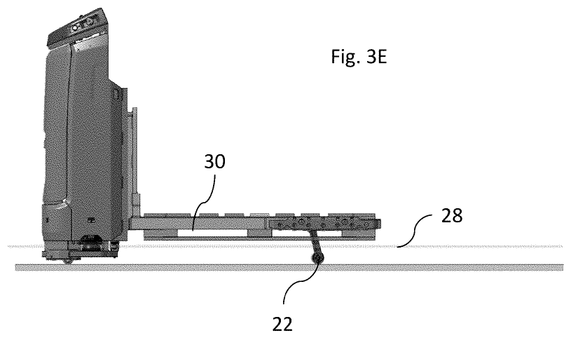

The basic idea of the pallet entry shown in FIG. 1C is that the vehicle enters the pallet opening without contacting it and is then set down on the first cross board with the front support roller, in order to drive further into the pallet with the aid of the support element and its support rollers. The support element may be configured as a roller conveyor with which the load arms roll over the cross boards 32, 36 and also the center board 34. As shown in FIGS. 2 and 3, the load wheels are folded into the load arms, so that they do not come into contact with the pallet. The roller track of the support element is a continuously shaped roller holder that can be attached to the load arm and carries the support rollers.

FIGS. 2A and 2B show an embodiment of a lifting sequence when entering into a closed pallet with a center board 34. With the pallet 30 shown, the center board 34 includes three partial boards arranged parallel to one another in the center of the pallet. In some embodiment, the cross boards 32 and 36 are significantly wider than the partial planks of the center plank 34. FIG. 2A shows the situation in which the vehicle 10 approaches the pallet 30. Here, the scanning plane 28 has a height that is smaller than the upper edge of the pallet 30. The pallet is detected via the scanning plane 28, as is the distance of the industrial truck 10 from the pallet 30.

FIG. 2B shows how the vehicle has adjusted its entry height for the pallet entry. FIG. 2C shows how a tip 38 of the load arm enters the pallet without contacting it. In the detailed view in FIG. 2C, the support element 40 can be clearly seen. In some embodiments, the support element 40 has seven support rollers 42A-G (for a better overview, only the support rollers 42A, B and G are designated in the figure). The support rollers 42 protrude slightly beyond a lower edge 44 of the load arm. The load arm tip 38 enters into the pallet opening until at least the first support roller 42G located at the front in the direction of entry is located above the cross board 32.

FIG. 2D shows the following situation, as the first support roller 42G is located above the cross board 32. Due to lowering the lifting mechanism, the load arm 18 is set down and the support roller 42G is set down on the cross board 32.

FIG. 2E shows the fully folded-in load wheel 22. In this case, the load wheel 22 is relieved and the load is carried by the support wheel 42G. The folding in of the load wheel 22 is effected by lowering the lifting element further, which causes the load wheels to fold in via lifting kinematics. If the support wheel 42G is set down, the vehicle can continue to enter into the pallet without using the load wheel. FIG. 2E shows the situation in which the load wheel fully enters and the support roller 42G takes over the load.

FIG. 2F shows how the vehicle enters further into the pallet. It can be seen that the load wheel 22 remains folded in. Here, the support element 40 with its roller track rolls from the cross board 32 to the center board 34 and from there to the second cross board 36. The support element with its support rollers is configured to be exactly long enough in relation to its longitudinal extension in the entry direction, so that it is possible to fully enter the pallet without using the load wheel.

FIG. 2G shows the situation in which the load wheel 22 is folded out between the second cross board 36 and the center board 34 facing the direction of entry. The pallet 30 is thus raised to driving height and the scanning plane 28 is free again to move the vehicle reliably. Once the vehicle has reached its target position, the steps shown in FIG. 2 are repeated in reverse order. In this way, the vehicle can exit a pallet, wherein the load wheel is folded in and the vehicle moves exclusively via the support element and with the support rollers over the cross and center boards.

FIG. 3 shows an embodiment of a lifting sequence for a closed pallet without a center board. Such pallets without a center board are, for example, CHEP pallets with a lengthwise entry. On a stringer pallet commonly used in the U.S., the narrowest cross board is 3.5 inches wide and the smallest distance from cross board to center board is 9.5 inches or 10 inches. For a Euro pallet, the minimum cross board width is 100 mm and the distance from the first cross board to the center board is 227.5 mm. This results in a maximum distance for the support wheels of 100 mm and a minimum length for the support element of approximately 230 mm.

FIG. 3A shows the entry of the load arm tip 38 into the pallet. In FIG. 3B, the load arm is set down on the front cross board 32. The vehicle now enters the pallet over the entire length of the support element 40 (see FIG. 3B). Since there is no center board, the load wheel 22 is folded out until the load arm 18 can be supported on the folded-out load wheel 22. The load wheel 22 is folded out before the end of the support element 40 is reached when it enters into the pallet. The vehicle 10 then further enters the pallet on the load wheel 22 until the raised position is reached and, as shown in FIG. 3E, the pallet can be raised. In the raised position shown in FIG. 3E, the scanning plane 28 is also released again. Once the target position for the pallet 30 has been reached, the steps shown in FIG. 3 are carried out in reverse order, in order to set the pallet down and pull the vehicle out of the pallet.

### LIST OF REFERENCE NUMBERS

10 Industrial truck
12 Drive section
14 Wheel
16 Lifting device
17 Kinematic rod
18 Load arm
20 Load wheel lever
22 Load wheel
26 Laser scanner
28 Scanning plane
30 Pallet
32 Cross board
34 Center board
36 Cross board
38 Load arm tip
40 Support element
42 Support rollers
44 Lower edge of the load arm

1. An industrial truck comprising:
a drive section; and
a load section including,
a load wheel lift comprising a support element,
a load arm, and
at least one load wheel positioned on the load arm,
wherein the at least one load wheel is configured to be pivoted via the load wheel lift into a folded-out position and into a folded-in position,
wherein the support element is configured to support the load arm when at least one load wheel is in the folded-in position,
wherein the support element supports the load arm when the load arm enters a pallet with the at least one load wheel in the folded-in position and without the at least one load wheel being supported on the pallet.

2. The industrial truck according to claim 1, wherein the support element includes at least two support rollers, and wherein a distance between the at least two support rollers is smaller than a smallest width of a narrowest cross board in the pallet.

3. The industrial truck according to claim 1, wherein the support element comprises a skid.

4. The industrial truck according to claim 1, wherein the support element is arranged on the load arm laterally next to the at least one load wheel.

5. The industrial truck according to claim 1, comprising:
two load arms; and
two support elements that are in each arranged on a side of one of the two load arms and pointing away from another of the two load arms.

6. The industrial truck according to claim 1, further comprising two support elements, wherein one of the two support elements is arranged to a left of the at least one load wheel and the other of the two support elements is arranged to a right and laterally next to the at least one load wheel in relation to a longitudinal direction of the load arm.

7. The industrial truck according to claim 2, wherein at least one of the at least two support rollers is arranged in front of the at least one load wheel along a longitudinal direction of the fork, and wherein at least one of the at least two support rollers is arranged in back of the at least one load wheel along the longitudinal direction of the fork.

8. The industrial truck according to claim 1, wherein the load arm comprises a U-shaped profile in a region of the at least one load wheel, and wherein when the at least one load wheel is in the folded-in position, the at least one load wheel is at least partially immersed in the U-shaped profile of the load arm.

9. The industrial truck according to claim 1, wherein the support element comprises a length that is greater than a first distance between a pallet board and a center board of a pallet along a direction of entry.

10. A method for driving into a closed pallet with an industrial truck, wherein the closed pallet includes at least one pallet pocket and the industrial truck includes a load section configured to be adjusted in height and including two fork tines that each include a support element extending along a longitudinal direction of each fork tine, the method comprising:
positioning the load section at a first lifting height,
moving the two fork tines into the at least one pallet pocket without contacting the at least one pallet pocket;
lowering the load section to a second lifting height if at least one portion of the support element is located above a pallet board, wherein at the second lifting height, the support element contacts the pallet board;
moving at least one load wheel to a folded-in position;
entering the pallet pockets with the at least one load wheel in the folded-in position such that the two fork tines are supported by the support elements on the pallet boards and the at least one load wheel does not support the two fork tines on the pallet boards; and
folding down load rollers and raising the pallet to transport height if the at least one load wheel is in a predetermined intermediate region that is free of pallet boards.

11. The method according to claim 10, further comprising structuring the industrial truck to comprise:
a drive section; and
a load section including,
a load wheel lift comprising a support element, and
a load arm including the at least one load wheel,
wherein the at least one load wheel is configured to be pivoted via the load wheel lift into a folded-out position and into a folded-in position,
wherein the support element is configured to support the load arm in the folded-in position of the at least one load wheel,
wherein the support element supports the load arm when the load arm enters a pallet when the at least one load wheel is in the folded-in position and without the at least one load wheel being supported on the pallet.
